(19) United States
(12) Patent Application Publication
(10) Pub. No.: US 2026/0086367 A1
(43) Pub. Date: Mar. 26, 2026

(54) OPTICAL CONFIGURATION FOR LIGHT PROJECTION SYSTEM

(71) Applicant: Texas Instruments Incorporated, Dallas, TX (US)

(72) Inventor: Zhongyan Sheng, Dallas, TX (US)

(21) Appl. No.: 19/252,914

(22) Filed: Jun. 27, 2025

Related U.S. Application Data
(60) Provisional application No. 63/697,674, filed on Sep. 23, 2024.

(51) Int. Cl. G02B 27/01

(52) U.S. Cl. CPC G02B 27/0172; G02B 2027/0112

(57) ABSTRACT

In one example, a system includes a spatial light modulator and a waveguide having a plurality of semi-reflectors disposed within the waveguide body. The waveguide body has first and second opposing sides and an entrance face that extends between the first and second opposing sides. The plurality of semi-reflectors extend between, and are angled with respect to, the first and second opposing sides. Individual semi-reflectors have respective different levels of angle-dependent reflectivity, with a first semi-reflector positioned closest to the entrance face having a lowest reflectivity level among the different levels of angle-dependent reflectivity. The waveguide is arranged to receive illumination light via the entrance face and to direct the illumination light, via the plurality of semi-reflectors, towards the spatial light modulator, and to receive, via the second opposing side, a projection beam from the spatial light modulator and to output the projection beam through the first opposing side.

### CROSS REFERENCE TO RELATED APPLICATIONS

This application claims priority to co-pending U.S. Provisional Patent Application No. 63/697,674 titled “ILLUMINATION CONFIGURATION FOR COMPACT, LOW COST PROJECTION OPTICAL SYSTEM USING SPATIAL LIGHT MODULATOR” and filed on Sep. 23, 2024, which is hereby incorporated herein by reference in its entirety.

### TECHNICAL FIELD

This description relates to light projectors, and more particularly, to optical arrangements for light projection systems using a spatial light modulator.

### BACKGROUND

Some optical projection systems use a spatial light modulator to project an image. In some configurations, a prism is used to optically couple the spatial light modulator to illumination optics (directing incoming light to the spatial light modulator) and to projection optics (directing outgoing light from the spatial light modulator to an image plane). However, these prisms tend to be bulky and thick, which increases the back working distance (distance between the spatial light modulator and the projection optics) of the system. As a result, the size of the optical projection system may be increased, in turn leading to increased complexity and cost.

### BRIEF DESCRIPTION OF THE DRAWINGS

FIG. 1 is a block diagram of a light projection system, according to an example.

FIG. 2A is a diagram of an augmented reality system in which the light projection system of FIG. 1 can be used, according to an example.

FIG. 2B is a block diagram of components of the light projection system of FIG. 1, according to an example.

FIG. 3A is a diagram showing a side view of an optical configuration of the light projection system of FIG. 1, according to an example.

FIG. 3B is a diagram showing a plan view of the optical configuration of FIG. 3A, according to an example.

FIG. 3C is a diagram showing a perspective view of the optical configuration of FIGS. 3A and 3B, according to an example.

FIG. 4A is a diagram of a waveguide, according to an example.

FIG. 4B is a diagram of a waveguide, according to another example.

FIG. 4C is a diagram illustrating a portion of an optical configuration of the light projection system of FIG. 1 including the waveguide of FIG. 4A, according to an example.

FIG. 5A is a diagram illustrating a through path cone angle of a projection beam from a spatial light modulator through a waveguide, according to an example.

FIG. 5B is a diagram illustrating a reflection path cone angle of illumination light directed through the waveguide to the spatial light modulator, according to an example.

FIG. 6 is a diagram illustrating an optical configuration of the light projection system of FIG. 1 including the components of FIG. 4C, according to an example.

### DETAILED DESCRIPTION

Techniques are described for reducing the size, cost, and/or weight of optical projection systems that include a spatial light modulator by replacing the coupling prism used in some systems with a relatively thin waveguide, thereby allowing the use of more compact and lower-cost imaging optics.

Accordingly, in one example, a system comprises a spatial light modulator and a waveguide having a waveguide body and a plurality of semi-reflectors disposed within the waveguide body. In some examples, the waveguide body has first and second opposing sides and an entrance face that extends between the first and second opposing sides, and the plurality of semi-reflectors extend between the first and second opposing sides and are angled with respect to the first and second opposing sides. In some examples, individual semi-reflectors of the plurality of semi-reflectors have respective different levels of angle-dependent reflectivity, with a first of the plurality of semi-reflectors positioned closest to the entrance face and having a lowest reflectivity level among the different levels of angle-dependent reflectivity. The waveguide may be arranged to receive illumination light via the entrance face and to direct the illumination light, via the plurality of semi-reflectors, towards the spatial light modulator. The waveguide can be further arranged to receive, via the second opposing side, a projection beam from the spatial light modulator and to output the projection beam through the first opposing side.

### General Overview

For various applications, it can be desirable to provide compact and low-cost optical systems that incorporate a spatial light modulator (SLM). For example, compact, low-cost SLM-based optical projection systems may be highly desirable in wearable display systems, such as augmented reality glasses.

Examples described herein provide a thin, non-scattering coupling waveguide to couple light into and out of an SLM in some optical systems. The waveguide can be positioned between a spatial light modulator and both illumination optics and projection optics so as to optically couple the spatial light modulator to the illumination optics and to the projection optics. As described further below, the waveguide may include a plurality of semi-reflectors embedded or otherwise located within the body of the waveguide. The semi-reflectors can be configured in terms of their orientation, size, and/or coating features to achieve a desired optical coupling performance. By replacing a thick and bulky prism with the thin waveguide, the back working distance of the optical system can be reduced, which in turn may allow for the use of more compact and cost-effective optical components.

Accordingly, in some examples, an optical system includes a spatial light modulator and a waveguide having a waveguide body and a plurality of semi-reflectors disposed within the waveguide body. Individual semi-reflectors of the plurality of semi-reflectors may have respective different levels of angle-dependent reflectivity, as described further below. In some examples, the waveguide body has first and second opposing sides and an entrance face that extends between the first and second opposing sides, with the plurality of semi-reflectors arranged to extend between the first and second opposing sides and be angled with respect to the first and second opposing sides. In some examples, the semi-reflector positioned closest to the entrance face may have a lowest level of angle-dependent reflectivity among the plurality of semi-reflectors. In some examples, the optical system further includes illumination optics and projection optics. The waveguide can be positioned to optically couple the spatial light modulator to the illumination optics and to the projection optics. In some examples, the optical system further includes a light source configured to emit illumination light. The waveguide may be arranged to receive the illumination light via the entrance face and to direct the illumination light, via the plurality of semi-reflectors, towards the spatial light modulator. The spatial light modulator may produce a projection beam response to the illumination light. The waveguide may be further arranged to receive, via the second opposing side, the projection beam from the spatial light modulator and to output the projection beam through the first opposing side.

These and other aspects are described in more detail below.

### Example System Architecture

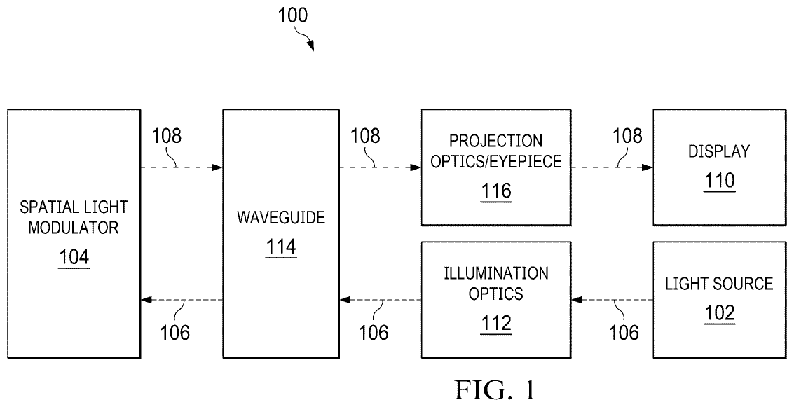

FIG. 1 is a block diagram of a light projection system 100, according to certain examples. In the illustrated example, the light projection system 100 includes a light source 102, a spatial light modulator (SLM) 104, a display 110, and a waveguide 114. The spatial light modulator 104 may be a digital micromirror device (DMD), a liquid crystal display (LCD) device, or a liquid crystal on silicon (LCoS) device, to name a few examples. The light source 102 can be configured and/or controlled to emit illumination light 106 (also referred to as an illumination beam 106). The system 100 may further include illumination optics 112 and projection optics 116, which in some examples may take the form of, or may include, an eyepiece. The light source 102 is optically coupled to the illumination optics 112. The light source 102, the illumination optics 112, the waveguide 114, and the spatial light modulator 104 may be arranged such that the illumination light 106 from the light source 102 is conveyed via the illumination optics 112 and the waveguide 114 to illuminate the spatial light modulator 104, which modulates the illumination light 106 to produce a projection beam 108. Accordingly, the spatial light modulator may be optically coupled to the light source 102 via the waveguide 114 and the illumination optics 112. The projection beam 108 from the spatial light modulator 104 may be conveyed via the waveguide 114 and the projection optics 116 to the display 110. Thus, the spatial light modulator 104 may be optically coupled to the display 110 via the waveguide 114 and the projection optics 116.

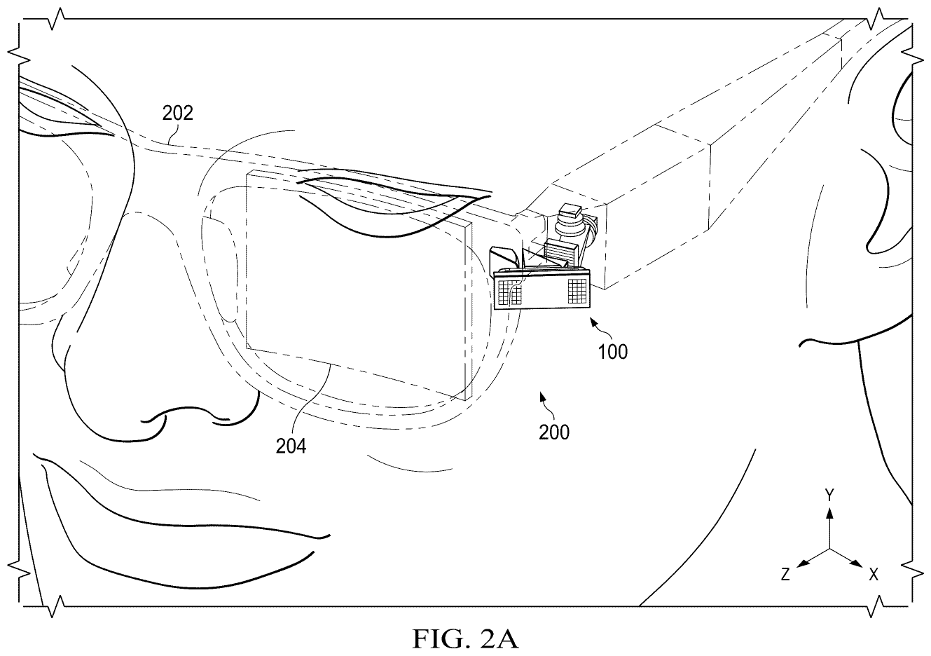

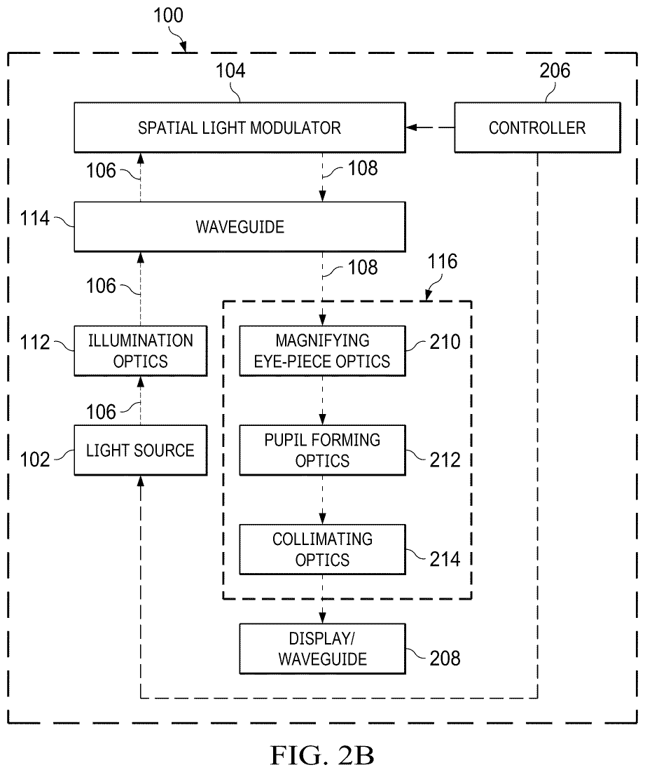

In some examples, the system 100 is representative of an image display system. For example, the system 100 may be representative of at least some components present in a digital projector. In some examples, the system 100 is representative of at least some components present in a portable or wearable display system, such as an augmented reality (AR) or virtual reality (VR) device, for example. FIG. 2A is a diagram illustrating an AR/VR headset 200, according to an example. The headset 200 includes a frame 202 and one or more light splitting optics 204 (e.g., one or more waveguides). The headset 200 further includes the light projection system 100 configured to control display of images to a wearer of the headset 200. According to certain examples, the light projection system 100 forms a pupil, and the human eye (of a wearer of the headset 200) acts as the last element in the optical chain, converting the light from the pupil into an image on the retina of the eye. In some examples in which the light splitting optics 204 are implemented using one or more transparent optical waveguides, the waveguide(s) collect light from the light projection system 100 and relay the light to the eye of the wearer.

FIG. 2B is a block diagram illustrating components of the light projection system 100, as may be used in the headset 200 and/or other display applications, according to an example. Referring to FIG. 2B, in some examples, the light projection system 100 includes a controller 206 that produces image data and control signals to control the spatial light modulator 104 to modulate the illumination light 106 so as to produce the projection beam 108 encoded with a particular image for display. The controller 206 further may be coupled to the light source 102 and configured to control the light source 102, responsive to the image data, to illuminate the spatial light modulator 104. Accordingly, in some examples, the controller 206 may include at least one processor and/or other electronics configured to appropriately control the spatial light modulator 104 and the light source 102. The light source 102 may include one or more light emitting diodes (LEDs), lasers, laser-phosphor light sources, or other light sources, in addition to any driver circuitry that may be needed to operate the light source(s) based on imaging information from the controller 206. The light source may be a single color (single channel) light source or multi-color (multi-channel) light source. The light source 102 illuminates the spatial light modulator 104, which, under control of the controller 206, produces the projection beam 108 responsive to the illumination light 106 received from the light source 102.

The projection beam 108 is passed via the projection optics 116 to a display or waveguide 208. In some examples, the display/waveguide 208 represents the display 110 of FIG. 1 or the light splitting optics 204 of FIG. 2A.

According to certain examples, the projection beam 108 is directed from the spatial light modulator 104, via the coupling waveguide 114, to the projection optics 116, as described above. As illustrated, in some examples (including some in which the system 100 is implemented in the AR/VR headset 200), the projection optics 116 may include magnifying eyepiece optics 210, pupil-forming optics 212, and collimating optics 214. The projection optics 116 projects an image responsive to the projection beam 108 received from the spatial light modulator 104. In some examples, such as in the AR/VR headset 200, rather than creating a real image on a display surface, the projection optics 116 form a pupil (e.g., using the pupil-forming optics 212) and the human eye acts as the last element in the optical chain, as described above, converting the light from the pupil into an image on the retina. Accordingly, the light splitting optics 204 can be implemented using one or more transparent optical waveguides that collect the light from the combination of the eyepiece optics 210, the pupil-forming optics 212, and optionally at least part of the collimating optics 214 and relay it to the eye. It will be appreciated that this optional display waveguide in element 208 is different from the waveguide 114 used for optically coupling the spatial light modulator 104 to the illumination optics 112 and to the projection optics 116. In some examples, the light relayed from the waveguide of element 208 towards the eye may pass through the collimating optics 214. It will be appreciated that numerous configurations and arrangements of the projection optics 116 are possible and intended to be covered by this disclosure. Further, the system 100 can be used in a variety of other applications and products, not limited to AR/VR headsets or other near-eye display systems.

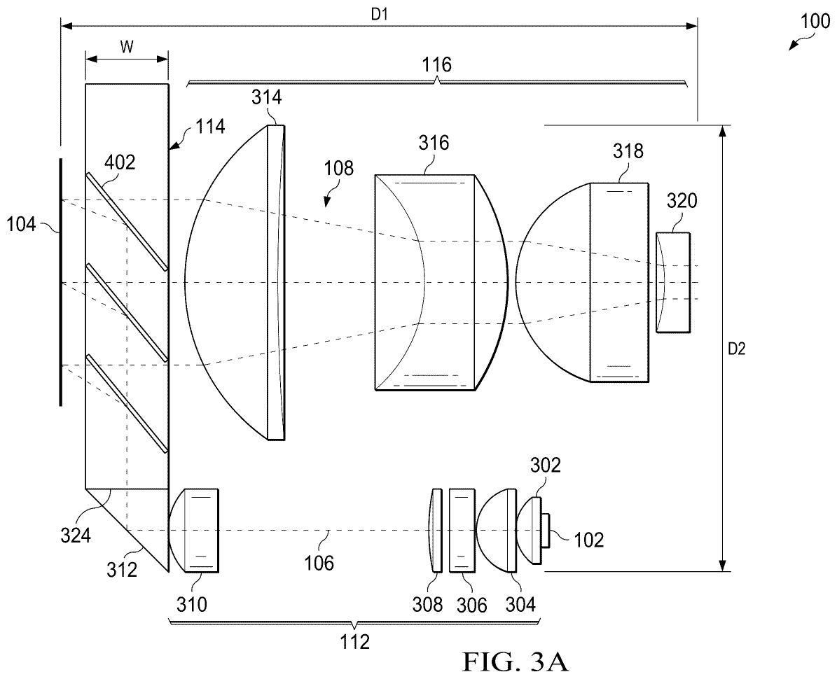

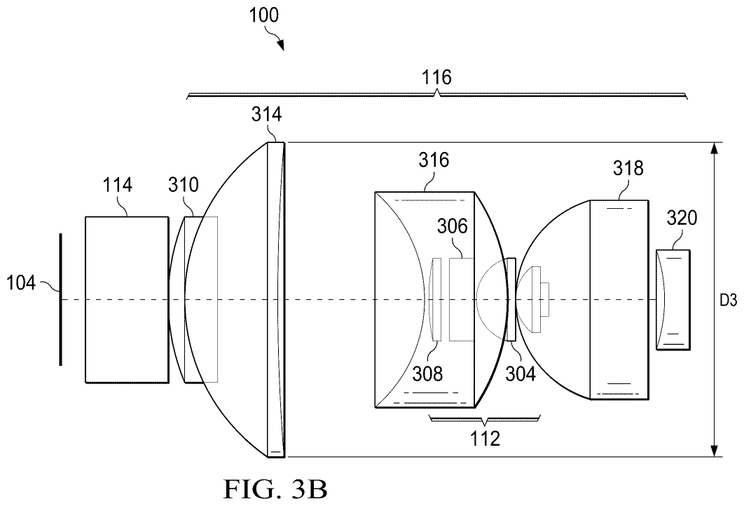

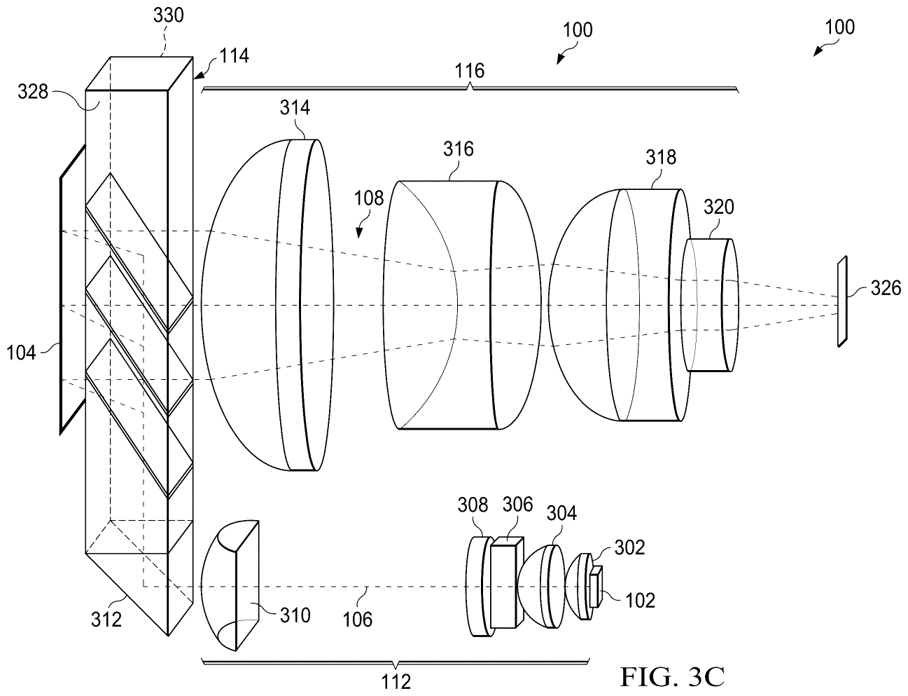

FIGS. 3A-C illustrate an example of an optical configuration of the light projection system 100. FIG. 3A shows a side view, FIG. 3B shows a plan view, and FIG. 3C shows a perspective view. The display 110, or display/waveguide 208, are not illustrated in FIGS. 3A-C. As described above, the illumination optics 112 direct the illumination light 106 from the light source 102 towards the waveguide 114, which in turn directs the illumination light 106 to the spatial light modulator 104. The waveguide 114 further directs the projection beam 108 from the spatial light modulator 104 to the projection optics 116. In some examples, a glass cover (not illustrated) can be positioned between the spatial light modulator 104 and the waveguide 114.

In the illustrated example, the illumination optics 112 includes a first collimating lens 302, a second collimating lens 304, a fly's eye array 306, a first relay lens 308, and a second relay lens 310. A fly's eye array is a two-dimensional array of individual optical elements (e.g., micro-lenses) assembled into a single optical element. The fly's eye array may be used to spatially transform the illumination light 106 from a nonuniform distribution to a substantially uniform irradiance distribution at an image plane of the illumination optics 112. The fly's eye array 306 is positioned between the collimating lenses 302, 304 and the relay lenses 308, 310, as shown. Thus, in some examples, the illumination light 106 travels from the light source 102 through the first and second collimating lenses 302, 304 to the fly's eye array 306, and from the fly's eye array 306 through the first relay lens 08 and then the second relay lens 310. Thus, the fly's eye array 306 is optically coupled to the light source 102 via the first and second collimating lenses 302, 304.

In the example of FIGS. 3A-C, the illumination light 106 is coupled from the second relay lens 310 into an entrance face 324 of the waveguide 114 via a folding prism 312. The folding prism 312 may be spaced apart from the second relay lens 310 such that a small air gap exists between the folding prism 312 and the second relay lens 310. In some examples, the folding prism 312 can be attached to the entrance face 324 of the waveguide 114. For example, the folding prism 312 can be adhered to the entrance face 324 of the waveguide 114 using an optical cement or other adhesive. In other examples, the folding prism 312 may be positioned with a small air gap between the folding prism 312 and the entrance face 324 of the waveguide 114. In some examples, the folding prism 312 is made of glass. However, in other examples, the folding prism 312 may be made of plastic or another material. In other examples, the folding prism 312 can be replaced with a folding mirror. However, using a folding mirror, rather than a folding prism, may increase the air gap between the illumination optics 112 and the folding mirror/waveguide 114, which may result in an increase in the back working distance of the system 100. In other examples, the illumination optics 112 can be positioned such that the illumination light 106 travels directly from the second relay lens 310 to the entrance face 324 of the waveguide 114. However, such an arrangement may be less compact than the configuration shown in FIGS. 3A-C.

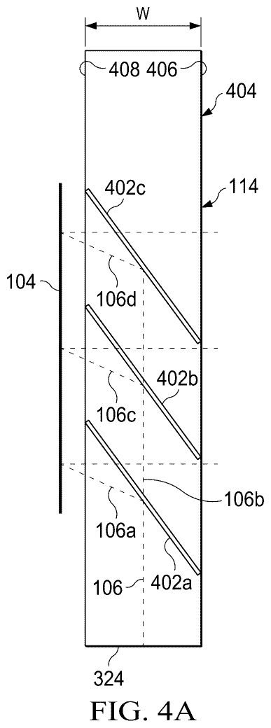

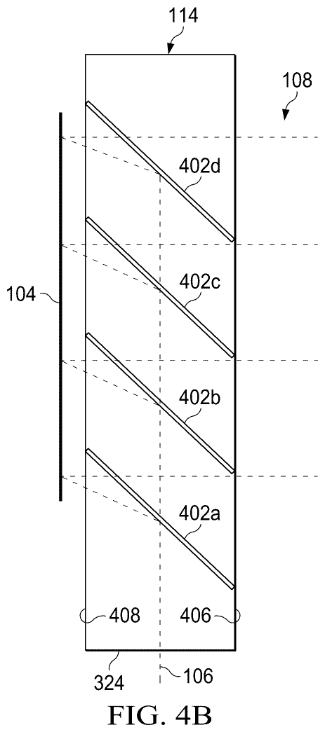

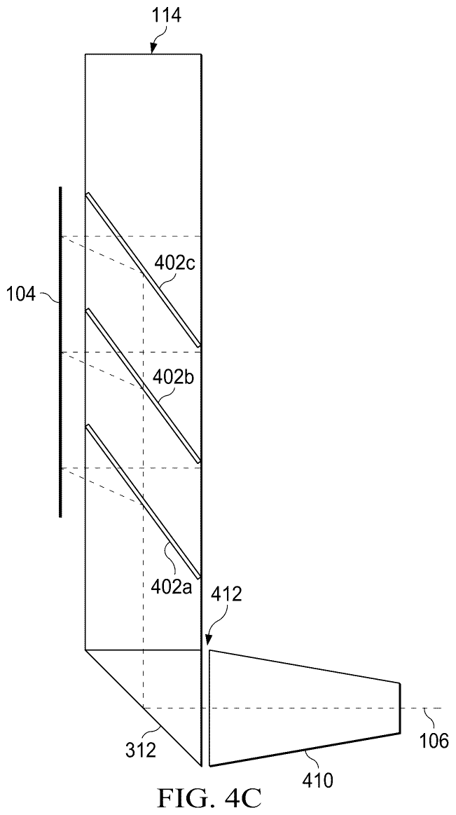

As described above, the waveguide 114 may include a plurality of semi-reflectors 402 positioned with the body of the waveguide 114. An example of the waveguide 114, including a plurality of semi-reflectors 402, is illustrated in FIG. 4A. In the illustrated example, the waveguide 114 includes three semi-reflectors, namely a first semi-reflector 402a, a second semi-reflector 402b, and a third semi-reflector 402c, located within a body 404 of the waveguide 114. In some examples, the body 404 of the waveguide 114 corresponds to an interior volume of the waveguide 114. The body 404 may be solid. For example, the waveguide 114 may be made of glass or plastic.

The waveguide 114 includes the entrance face 324 via which the illumination light 106 is received into the waveguide body 404. The waveguide 114 further includes first and second opposing sides 406, 408. In some examples, the first and second opposing sides 406, 408 are substantially parallel to one another, and the entrance face 324 extends between, and is substantially perpendicular to, the first and second opposing sides, as shown in FIG. 4A. Thus, the waveguide 114 may be rectangular in such examples.

According to certain examples, the semi-reflectors 402 are positioned to extend between the first and second opposing sides 406, 408 of the waveguide 114, and are angled with respect to the first and second opposing sides 406, 408, as shown in FIGS. 4A-C. The individual semi-reflectors 402 may include a substrate with one or more coatings disposed thereon, as described further below. The substrate may be made of glass or plastic, for example. According to certain examples, the illumination light 106 enters the waveguide body 404 via the entrance face 324 and is incident on the first semi-reflector 402a. The first semi-reflector 402a may be configured to reflect a first portion 106a of the illumination light 106 to the spatial light modulator 104 and to transmit a second portion 106b of the illumination light 106 to the second semi-reflector 402b. The second semi-reflector 402b may be configured to reflect a third portion 106c of the second portion 106b of the illumination light 106 to the spatial light modulator 104 and to transmit a fourth portion 106d of the second portion 106b of the illumination light 106 to the third semi-reflector 402c. The third semi-reflector 402c may be configured to reflect the fourth portion 106d of the second portion 106b of the illumination light 106 to the spatial light modulator 104. Thus, in some examples, the third semi-reflector 402c may be considered a reflector since it may reflect substantially all of the light incident thereon (at least within a particular range of angles of incidence).

In the examples shown in FIGS. 4A and 4C, the waveguide 114 includes three semi-reflectors 402a-c. However, in other examples, the waveguide 114 may include fewer than three semi-reflectors or more than three semi-reflectors. For example, FIG. 4B illustrates an example of the waveguide 114 including four semi-reflectors 402. Thus, in the example of FIG. 4B, the waveguide 114 includes a fourth semi-reflector 402d in addition to the first, second, and third semi-reflectors 402a0c. In such examples, the third semi-reflector 402c may reflect some of the illumination light 106 incident thereon to the spatial light modulator 104, while transmitting some of the illumination light to the fourth semi-reflector 402d. Those skilled in the art will appreciate, given the benefit of this disclosure, that this arrangement may extended to more than four semi-reflectors. The plurality of semi-reflectors 402 act to homogenize the illumination light 106 passing through the waveguide 114 to the spatial light modulator 104, and allow the thickness, W, of the waveguide to be relatively thin (e.g., a few millimeters). As a result, the back working distance of the system 100 can be reduced relative to systems that use a thick coupling prism, as described above. Including more than three semi-reflectors may further reduce the back working distance of the system 100, but may also reduce the etendue of the light source 102. Therefore, for any given application, the number of semi-reflectors 402 may be selected to achieve a balance or trade-off between a desired back working distance and source etendue.

As shown in FIGS. 4A-C, the plurality of semi-reflectors 402 at least partially reflect the illumination light 106 towards the second opposing side 408 of the waveguide 114, while allowing the projection beam 108 to pass through to exit the waveguide 114 via the first opposing side 406. Accordingly, as described above, the plurality of semi-reflectors 402 may have angle-dependent reflectivity. For example, the plurality of semi-reflectors 402 may be at least semi-reflective to light incident within a first range of angles of incidence and transmissive to light within a second range of angles of incidence. The angle of incidence ranges may be measured within the material of the body 404 of the waveguide 114, rather than in air or free space.

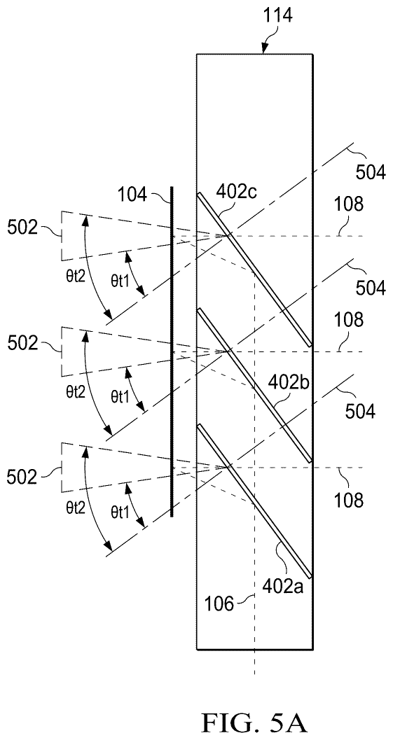

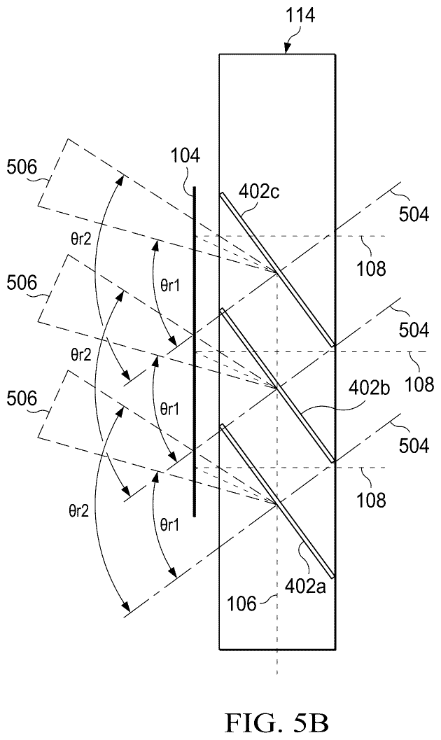

Referring to FIG. 5A, in some examples, the through path (e.g., light of the projection beam 108 being transmitted through the semi-reflectors 402) may include incidence angles (through path cone angle 502) in a range of 30-40 degrees. The through path cone angle 502 for each semi-reflector 402 may be measured relative to a surface normal 504 of the semi-reflector 402. Thus, the through path cone angle 502 may include a range of angles from θt1 to θt2 (e.g., 30-40 degrees for θt1=30 degrees and θt2=40 degrees), as shown in FIG. 5A. In some examples, the semi-reflectors 402 can be configured to have a reflectivity in a range of approximately 0%-5% in the through path. Thus, the semi-reflectors 402 may allow substantially all (e.g., 95%-100%) of the light of the projection beam 108 to pass through the semi-reflectors towards the first opposing side 406 of the waveguide 114 (and beyond).

Referring to FIG. 5B, in some examples, the reflection path (e.g., the illumination light 106 incident on the semi-reflectors 402) may include incidence angles (reflection path cone angle 506) in a range of approximately 50-60 degrees. The reflection path cone angle 506 for each semi-reflector 402 may be measured relative to the surface normal 504. Thus, the reflection path cone angle 506 may include a range of angles from θr1 to θr2 (e.g., 50-60 degrees for θr1=50 degrees and θr2=60 degrees), as shown in FIG. 5B. In some examples, the illumination light 106 may be incident on the entrance face 324 of the waveguide 114 at approximately 90 degrees (e.g., normal or perpendicular to the entrance face 324). Accordingly, the nominal angle of incidence of the illumination light 106 on the semi-reflectors 402 can be controlled by angling the semi-reflectors 402 with respect to the entrance face 324 (and therefore with respect to the first and second opposing sides 406, 408 of the waveguide), as shown.

Referring again to FIG. 3C and to FIGS. 4A-C, in some examples, the waveguide 114 further comprises two sidewalls 328, 330 (also referred to as third and fourth sides 328, 330), which are perpendicular to the surface 324 and to the first and second opposing sides 406 and 408. In some examples, the third and fourth sides 328, 330 have polished surfaces (e.g., the surfaces that are internal to the waveguide 114 and face one another) that can reflect the illumination light 106, so that the incoming illumination light 106 is contained within the waveguide 114 without leaking out through the sidewalls 328, 330. The reflective property of the sidewalls 328, 330 can be achieved through total internal reflection (TIR), which does not need any coating on the surfaces of the sidewalls 328, 330, or through a mirror coating on the sidewalls 328, 330. In some examples, the distance between the two sidewalls 328, 330 is slightly larger than the corresponding dimension of the spatial light modulator 104 such that the illumination footprint covers the full extent of the spatial light modulator 104 and allows some tolerance for alignment errors.

The semi-reflectors 402 may have angle-dependent reflectivity in that their reflectivity varies depending on the angle of incidence of the light incident on the semi-reflectors. Furthermore, according to certain examples, the individual semi-reflectors 402a-c (and optionally 402d) may have respective different levels of angle-dependent reflectivity in the reflection path. For example, as described above, the first semi-reflector 402a allows the second portion 106b of the illumination light 106 to pass through to the second semi-reflector 402b, and so forth; whereas the third semi-reflector 402c may reflect substantially all the incident illumination light 106 (e.g., fourth portion 106d) towards the second opposing side 408 of the waveguide 114. Thus, in some examples, the first semi-reflector 402a, positioned closest to the entrance face 324 of the waveguide 114, may have a lowest reflectivity level among the different levels of angle-dependent reflectivity. In some examples, the first semi-reflector 402a has a reflectivity (in the reflection path) of approximately 25%-34% (±3%). The second semi-reflector 402b may have a reflectivity (in the reflection path) of approximately 45%-50% (±4%). The third semi-reflector 402c may have a reflectivity (in the reflection path) of approximately 80%-100% (−5%). It will be appreciated that, in other examples, the individual semi-reflectors 402 may be configured with different levels of reflectivity in the reflection path. The third semi-reflector 402c may include an air gap between two or more structural layers of the semi-reflector 402c. The provision of an air gap may facilitate achieving the desired reflectivity in the illumination path and transmission in the projection path.

In some examples, the angle-dependent reflectivity of respective individual semi-reflectors 402 can be configured though coatings applied on at least a surface of the semi-reflector that faces the incident light. For example, the individual semi-reflectors 402 each include a substrate and may have a particular coating on at least one surface of the substrate (the coating being on at least the surface of the substrate that faces the incident illumination light 106 and incident projection beam 108). The material(s) and/or thickness of the coatings can be selected to provide a particular angle-dependent reflectivity for the respective individual semi-reflectors 402a-c, for example. Examples of coating materials that can be used include silicon dioxide (SiO₂), titanium dioxide (TiO₂), magnesium fluoride (MgF₂), and aluminum oxide (Al₂O₃). In some examples, the angle-dependent reflectivity is a polarization-averaged value. In some examples, the tolerances provided above (or different tolerance ranges used in other examples) may also apply on ripple across the wavelength range of the illumination light 106 and/or projection beam 108. In some examples, the angle-dependent reflectivity of respective semi-reflectors can be set (e.g., through configuration of the coatings) based on one or more nominal wavelengths. For example, the first semi-reflector 402a may be configured to have a nominal reflectivity in the reflection path of 25% for a nominal green wavelength of 525 nanometers (nm), and may therefore have slightly different reflectivity (e.g., within the tolerance range) for red and/or blue light, and for green light in the green wavelength range but not exactly 525 nm. It will be appreciated that the nominal (or baseline) reflectivity for any semi-reflector 402 may be configured for any nominal wavelength, not limited to the example provided above.

Referring again to FIGS. 3A-C, the projection beam 108 exits the first opposing side of the waveguide 114 and travels to the projection optics 116, as described above. In the example illustrated in FIGS. 3A-C, the projection optics 116 includes a group of four lenses 314, 316, 318, and 320. As described above, these lenses 314, 316, 318, and 320 together may form an image, responsive to the projection beam 108, at an image plane 326. The display 110 may be positioned at the image plane 326, for example. In some applications, such as where the system 100 is used in the AR/VR headset 200, for example, it may be preferable for the projection optics 116 to have an external pupil. Accordingly, in some examples, the lenses 314, 316, 318, and 320 together may be configured as an eyepiece to form a pupil, or virtual image, at the image plane 326 (where the light splitting optics 204 may be placed, for example). However, in other examples, the projection optics 116 can form a real image at the image plane 326 for projector applications in which a display screen is positioned at the image plane 326. It will be appreciated that in other examples, the projection optics 116 may include more than, or fewer than, the four lenses 314, 316, 318, 320 illustrated in FIGS. 3A-C. Further, in other examples, any one or more of the lenses 314, 316, 318, and/or 320 may have a different configuration than that shown (e.g., different radii of curvature, different optical profiles, etc.). For example, in some instances, the projection optics 116 can be configured to perform at least some correction for chromatic (color) and/or optical aberrations, which may influence the optical configuration of one or more of the lenses 314, 316, 318, 320; whereas in other examples, color correction and/or distortion correction can be performed through image processing (e.g., by the controller 206). In addition, in other examples, the projection optics 116 may be implemented using reflective optics (e.g., one or more mirrors), rather than refractive optics, as shown, or may be implemented using a combination of reflective and refractive optics. Numerous variations will be apparent to those skilled in the art, given the benefit of this disclosure.

As described above, according to certain examples, the waveguide 114 may be relatively thin compared to a relatively thick coupling prism that may otherwise be used to optically couple the spatial light modulator 104 to the illumination optics 112 and to the projection optics 116. For example, the waveguide 114 may have a thickness, W, of approximately 3 millimeters (mm), whereas a coupling prism in a comparable system may have a thickness (in the same dimension as W) of about 12 mm. Thus, the back working distance of the system 100 can be reduced. Reducing the back working distance may offer advantages in terms of the overall size or compactness of the system 100, and further, may simply the design/configuration of the projection optics 116, which can reduce cost. For example, when the back working distance is relatively large, designing lenses for the projection optics 116 that can accommodate the full cone angle of the projection beam, without clipping and/or producing stray light paths, can be challenging. In addition, in such cases, at least the lens 314 may need to be large, which may increase the cost and weight of the system 100.

According to certain examples, using the waveguide 114, the overall system 100 can be made compact and allow for the use of short-throw or ultra-short-throw lenses in the projection optics 116. The “throw” of the projection optics 116 refers to the distance between the optical element(s) and the image plane 326. Having a short throw is advantageous in numerous applications, including some projectors and AR/VR headsets. For example, a short-throw projector allows a large image to be projected onto a surface that is relatively close to the projector itself, which can be desirable in space-constrained environments (e.g., small rooms, headsets, etc.) where it may not be possible to position the projector (or projection optics) far from the display surface.

The following example illustrates the ability to provide a compact system 100 using the waveguide 114. In this example, the optical system (illumination optics 112 and projection optics 116) has the configuration illustrated in FIGS. 3A-C and includes the glass cover (not illustrated) positioned between the spatial light modulator 104 and the waveguide 114, and the following parameters apply:
The spatial light modulator 104 is implemented as a digital mirror device (DMD) and comprises a two-dimensional array of pixels, having array dimensions of 4.89 mm by 8.69 mm;
The optical system has an F-stop of F/3.8 with a cone angle of 7.6 degrees;
The optical system has a diagonal field of view of 52 degrees, with a pupil diameter of 3 mm;
The thickness of the glass cover (measured in the dimension of W) is 0.7 mm;
The air gap between the glass cover and the spatial light modulator 104 is 0.307 mm;
The air gap between the folding prism 312 and the waveguide 114 is 0.15 mm; and
The thickness, W, of the waveguide 114 is 2.95 mm;
   In one example having the above parameters, the system 100 has the following dimensions: D1=23.4 mm; D2=16.4 mm; and D3=12 mm. This example demonstrates that the system 100 can be implemented in a very compact form while meeting good and useful performance specifications.

In some instances, it can be desirable to homogenize the illumination light 106 from the light source 102 to provide a relatively uniform illumination across the spatial light modulator 104. This may allow for higher quality image generation, without variations in brightness or other parameters caused by non-uniform illumination on the spatial light modulator 104. As described above, in some examples, the illumination optics 112 include the fly's eye array 306 to homogenize the illumination light 106. Further, in some examples, the waveguide 114 acts as light tunnel that homogenizes the illumination light 106 directed towards the spatial light modulator 104. The waveguide 114 can be configured (e.g., the thickness, W, can be fixed) such that there is total internal reflection between the first and second opposing sides 406, 408 of the illumination light 106, for at least a certain cone angle of incidence of the illumination light 106 on the entrance face 324. Total internal reflection may allow the illumination light 106 to undergo numerous reflections inside the waveguide body 404, which may homogenize the light. Further, the angle-dependent reflectivity levels of the semi-reflectors 402 can be configured such that the intensities of the portions 106a, 106c, 106d are substantially equal.

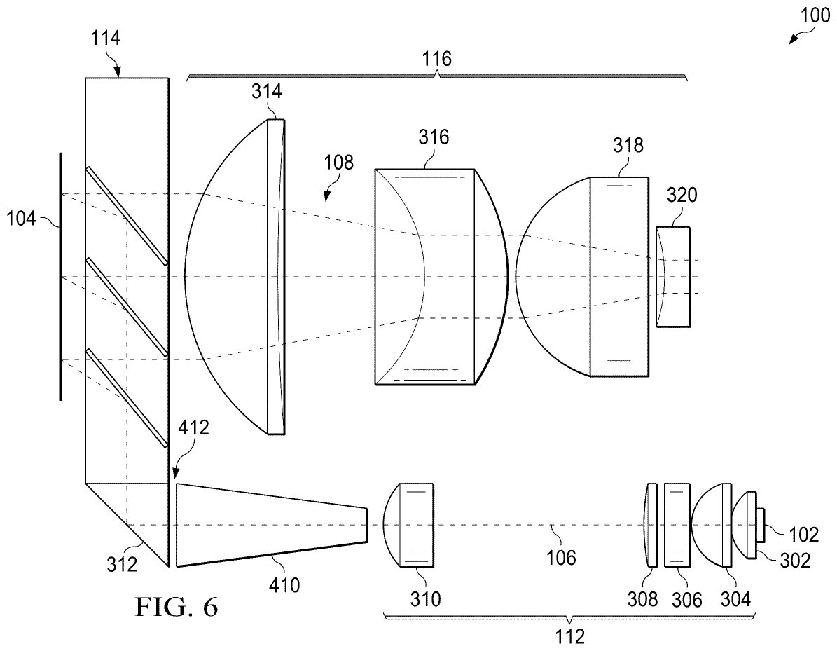

Referring again to FIG. 4C, in some examples, the illumination optics 112 include a light tunnel 410. The light tunnel 410 may be positioned with a small air gap 412 between the light tunnel 410 and the folding prism 312. FIG. 6 illustrates a variation of the system 100 including the light tunnel 410 positioned between the illumination optics 112 and the folding prism 312. Thus, the illumination optics 112 may be optically coupled to the folding prism 312 via the light tunnel 410. The illumination light 106 may be directed from the second relay lens 310 to an entrance of the light tunnel 410, and from an exit of the light tunnel 410 to the folding prism 312. Thus, the light tunnel 410 may convey the illumination light 106 (received at an entrance of the light tunnel 410 from the illumination optics 112) to the folding prism 312, which directs the illumination light 106 into the waveguide 114 as described above. In some examples, the illumination optics 112 and the projection optics 116 are configured and operate in the same manner(s) as described above with reference to FIGS. 3A-C and are therefore not further described here.

As described above, in some examples, it may be preferable to illuminate the spatial light modulator 104 with uniform (or approximately uniform) illumination light 106. The waveguide 114 performs some homogenization of the illumination light 106, as described above; however, in some examples, one or more additional homogenizing elements can be used to achieve relatively uniform illumination at the spatial light modulator 104. Further, it may be preferable that the illumination light 112 incident as the spatial light modulator 104 has ray angles within certain cone angle across the active array area of the spatial light modulator 104. As described above, in some examples, the illumination optics 112 may include one or more homogenizing elements, such as the fly's eye array 306. However, the illumination light 106 at the entrance to the light tunnel 410 still may not be uniformly distributed and the ray angles may not match cone angle desired for illuminating the spatial light modulator 104. Accordingly, the light tunnel 410 can be used for further homogenization of the illumination light 106 and, in some examples, modification of the cone angle of the light rays of the illumination light 106.

In some examples, multiple reflections of the illumination light 106 inside the light tunnel 410 homogenizes (or further homogenizes) the illumination light 106, similar to the homogenization that may occur within the waveguide body 404, as described above. In some examples, the light tunnel 410 may be made of glass; however, other materials may be used in other examples. In some examples, the light tunnel 410 is tapered, as shown in FIGS. 4C and 6. However, in other examples, the light tunnel 410 may not be tapered. Both tapered and non-tapered light tunnels 410 may homogenize the incoming illumination light 106 to produce a uniform (or more uniform) distribution at the exit of the light tunnel 410. In addition, a tapered light tunnel 410 may change the cone angle of the illumination light 106. In some examples, if sufficient homogenization of the illumination light 106 is achieved using the waveguide 114, optionally in combination with the light tunnel 410, the fly's eye array 306 can be omitted. The fly's eye array 306 and/or the light tunnel 410 may be replaced with other homogenizing optical elements.

Thus, aspects and examples provide a compact optical projection system that includes a spatial light modulator to produce an image and uses a coupling waveguide to optically couple the spatial light modulator to a light source (via illumination optics) for illumination of the spatial light modulator and to projection optics to allow for projection of the image produced by the spatial light modulator. The use of the coupling waveguide may advantageously reduce the back working distance of the optical projection system, thereby allowing for a compact design while also simplifying the design/implementation of the projection optics and reducing the system cost.

### CONCLUSION

The above descriptions relating to light projection systems, imaging systems, and/or image display systems provide only some examples of environments or applications within which techniques and structures described herein may be implemented.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Elements that are “optically coupled” have an optical path between them. For example, element A and element B are optically coupled if light may travel from element A to element B and/or light may travel from element B to element A. Being optically coupled do not require light to be actively propagating between the elements. Optically coupled elements are in an arrangement where light, if present, is capable of propagating from element A to element B or from element B to element A. Additionally, elements that are optically coupled may have additional elements, for example lenses, mirrors, prisms, light tunnels, or other optical elements, in the light path between them.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within a range of that parameter, such as +/−10 percent of that parameter or +/−5 percent of that parameter.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples described herein can be practiced without certain, specific details. In other instances, well known methods, procedures, components, and circuitry have not been described in detail to avoid unnecessarily obscuring aspects of the examples. Accordingly, the scope of the present disclosure is defined by the appended claims rather than the foregoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### Further Examples

The following examples pertain to further arrangements and/or implementations, from which numerous permutations and configurations will be apparent.

Example 1 is a system comprising: a spatial light modulator; and a waveguide having a waveguide body and a plurality of semi-reflectors disposed within the waveguide body. The waveguide body has first and second opposing sides and an entrance face that extends between the first and second opposing sides. The plurality of semi-reflectors extend between the first and second opposing sides and are angled with respect to the first and second opposing sides. Individual semi-reflectors of the plurality of semi-reflectors have respective different levels of angle-dependent reflectivity, with a first of the plurality of semi-reflectors positioned closest to the entrance face and having a lowest reflectivity level among the different levels of angle-dependent reflectivity. The waveguide is arranged to receive illumination light via the entrance face and to direct the illumination light, via the plurality of semi-reflectors, towards the spatial light modulator. The waveguide is further arranged to receive, via the second opposing side, a projection beam from the spatial light modulator and to output the projection beam through the first opposing side.

Example 2 includes the system of Example 1, wherein the individual semi-reflectors of the plurality of semi-reflectors each comprise a substrate and a semi-reflective coating on a surface of the substrate.

Example 3 includes the system of one of Examples 1 or 2, wherein: for light incident on the plurality of semi-reflectors in a first range of angles of incidence, the plurality of semi-reflectors have a reflectivity value in a range of approximately 0%-5%; and for light incident on the plurality of semi-reflectors in a second range of angles of incidence different from the first range of angles of incidence, the individual semi-reflectors have the respective different levels of angle-dependent reflectivity in a range of approximately 25% to 100%.

Example 4 includes the system of Example 3, wherein: the first semi-reflector positioned closest to the entrance face and has, for the light in the second range of angles of incidence, a reflectivity in a range of approximately 25%-34%; a second semi-reflector of the plurality of reflectors has, for the light in the second range of angles of incidence, a reflectivity in a range of approximately 45%-50%; a third semi-reflector of the plurality of reflectors has, for the light in the second range of angles of incidence, a reflectivity in a range of approximately 80%-100%; and the second semi-reflector is positioned between the first and third semi-reflectors.

Example 5 includes the system of Example 4, wherein the first range of angles of incidence is approximately 30-40 degrees, and wherein the second range of angles of incidence is approximately 50-60 degrees.

Example 6 includes the system of one of Examples 3 or 4, wherein the third semi-reflector includes an air gap.

Example 7 includes the system of any one of Examples 1-6, wherein the waveguide body is made of plastic or glass.

Example 8 includes the system of any one of Examples 1-7, wherein the waveguide body further includes third and fourth opposing sides positioned substantially perpendicular to, and extending between, the first and second opposing sides, and positioned substantially perpendicular to the entrance face, the third and fourth opposing sides configured to reflect the illumination light within the body of the waveguide.

Example 9 includes the system of Example 8, wherein the third and fourth opposing sides are arranged for total internal reflection of the illumination light within a predetermined illumination cone angle.

Example 10 includes the system of Example 8, wherein the third and fourth opposing sides comprise a reflection coating.

Example 11 includes the system of Example 8, wherein the third and fourth opposing sides have mirrored surfaces that face one another.

Example 12 includes the system of any one of Examples 1-11, wherein the spatial light modulator is configured to modulate the illumination light received from the waveguide to produce the projection beam.

Example 13 is a light projection system comprising: a light source; a spatial light modulator; projection optics; a waveguide optically coupled to the light source, the spatial light modulator, and the projection optics, the waveguide having a waveguide body and including a plurality of semi-reflectors disposed within the waveguide body, individual semi-reflectors of the plurality of semi-reflectors having respective different levels of angle-dependent reflectivity, and the waveguide being positioned such that the spatial light modulator is optically coupled to the projection optics via the waveguide; and illumination optics optically coupled to the light source and to the waveguide, the illumination optics and the waveguide positioned such that the light source is optically coupled to the spatial light modulator via the illumination optics and the waveguide.

Example 14 includes the light projection system of Example 13, wherein: the light source is configured to emit illumination light; the illumination optics are configured to direct the illumination light to the waveguide; the plurality of semi-reflectors includes a first semi-reflector, a second semi-reflector, and a third semi-reflector; the first semi-reflector being configured to reflect a first portion of the illumination light to the spatial light modulator and to transmit a second portion of the illumination light to the second semi-reflector; the second semi-reflector being configured to reflect a third portion of the second portion of the illumination light to the spatial light modulator and to transmit a fourth portion of the second portion of the illumination light to the third semi-reflector; and the third semi-reflector being configured to reflect the fourth portion of the second portion of the illumination light to the spatial light modulator.

Example 15 includes the light projection system of Example 14, wherein the first portion of the illumination light is in a range of approximately 25%-34% of the illumination light; and wherein the third portion of the second portion of the illumination light is in a range of approximately 45%-50% of the third portion of the second portion of the illumination light.

Example 16 includes the light projection system of one of Examples 14 or 15, wherein the spatial light is configured to produce a projection beam responsive to the illumination light; and wherein the projection optics are configured to image the projection beam onto a focal plane.

Example 17 includes the light projection system of Example 16, wherein the projection optics comprises an eyepiece.

Example 18 includes the light projection system of any one of Examples 14-17, further comprising a folding prism optically coupled to the illumination optics and to the waveguide, and configured to direct the illumination light from the illumination optics into an entrance face of the waveguide.

Example 19 includes the light projection system of Example 18, wherein the folding prism is attached to the waveguide.

Example 20 includes the light projection system of one of Examples 18 or 19, further comprising a light tunnel optically coupled to the illumination optics and to the folding prism, the light tunnel configured to homogenize the illumination light received from the illumination optics and to direct the illumination light to the folding prism.

Example 21 includes the light projection system of Example 20, wherein the light tunnel is tapered.

Example 22 includes the light projection system of any one of Examples 14-21, wherein the waveguide body is made of glass or plastic.

Example 23 includes the light projection system of any one of Examples 14-22, wherein the individual semi-reflectors of the plurality of semi-reflectors comprise a substrate and a semi-reflective coating on a surface of the substrate.

Example 24 includes the light projection system of Example 23, wherein the third semi-reflector includes an air gap between layers of the substrate.

Example 25 includes the light projection system of any one of Examples 14-24, wherein: the waveguide body is substantially rectangular, having first and second opposing parallel sides, third and fourth opposing parallel sides arranged perpendicular to the first and second opposing parallel sides, and an entrance face that extends between the first and second opposing parallel sides and between the third and fourth opposing parallel sides, the entrance face arranged perpendicular to the first, second, third, and fourth opposing parallel sides, the third and fourth opposing parallel sides spaced apart from one another by a distance such that the waveguide exhibits total internal reflection of the illumination light within a predetermined illumination cone angle; and each of the plurality of semi-reflectors is angled with respect to the first and second opposing parallel sides.

Example 26 includes the light projection system of claim 25, wherein the third and fourth opposing parallel sides have mirrored surfaces.

Example 27 includes the light projection system of any one of Examples 14-24, wherein the waveguide body is substantially rectangular, having first and second opposing parallel sides, third and fourth opposing parallel sides arranged perpendicular to the first and second opposing parallel sides, and an entrance face that extends between the first and second opposing parallel sides and between the third and fourth opposing parallel sides, the entrance face arranged perpendicular to the first, second, third, and fourth opposing parallel sides, the third and fourth opposing parallel sides having a reflective coating that reflects the illumination light within the waveguide body.

Example 28 includes the light projection system of any one of Examples 14-27, wherein the illumination optics comprises: one or more collimating lenses; one or more relay lenses; and a micro-lens array positioned in an illumination optical path between the one or more collimating lenses and the one or more relay lenses.

Example 29 includes the light projection system of Example 28, wherein the micro-lens array is configured to transform the illumination light into a square pattern and to homogenize the illumination light.

Example 30 includes the light projection system of any one of Examples 14-29, further comprising a cover glass plate positioned between the spatial light modulator and the waveguide.

Example 31 is an augmented reality headset comprising: a frame; and a light projection system coupled to the frame and configured to project a virtual image. The light projection system includes a light source configured to emit illumination light, a spatial light modulator configured to produce a projection beam responsive to the illumination light, a waveguide having a waveguide body and including a plurality of semi-reflectors disposed within the waveguide body and configured to reflect the illumination light to the spatial light modulator, individual semi-reflectors of the plurality of semi-reflectors having respective different levels of angle-dependent reflectivity, and an eyepiece arranged to receive the projection beam from the spatial light modulator via the waveguide, the eyepiece configured to form the virtual image.

Example 32 includes the augmented reality headset of Example 31, further comprising a display waveguide mechanically coupled to the frame and optically coupled to the eyepiece, the display waveguide configured to relay the virtual image.

Example 33 includes the augmented reality headset of one of Examples 31 or 32, wherein the plurality of semi-reflectors includes: a first semi-reflector configured to reflect a first portion of the illumination light to the spatial light modulator and to transmit a second portion of the illumination light to a second semi-reflector, the second semi-reflector configured to reflect a third portion of the second portion of the illumination light to the spatial light modulator and to transmit a fourth portion of the second portion of the illumination light to a third semi-reflector, and the third semi-reflector configured to reflect the fourth portion of the second portion of the illumination light to the spatial light modulator.

Example 34 includes the augmented reality headset of Example 33, wherein the third semi-reflector includes an air gap.

Example 35 includes the augmented reality headset of any one of Examples 31-34, wherein: the waveguide body is substantially rectangular, having first and second opposing parallel sides and third and fourth opposing parallel sides arranged perpendicular to the first and second opposing parallel sides, the third and fourth opposing parallel sides spaced apart from one another by a distance configured for total internal reflection of the illumination light within a predetermined illumination cone angle; and each of one or more of the plurality of semi-reflectors extends between and is angled with respect to the first and second opposing parallel sides.

Example 36 includes the augmented reality headset of any one of Examples 31-34, wherein the waveguide body is substantially rectangular, having first and second opposing parallel sides, third and fourth opposing parallel sides arranged perpendicular to the first and second opposing parallel sides, and an entrance face arranged perpendicular to the first, second opposing parallel sides and to the third, and fourth opposing parallel sides, wherein each of one or more of the plurality of semi-reflectors extends between and is angled with respect to the first and second opposing parallel sides, and wherein the third and fourth opposing parallel sides have reflective surfaces that reflect the illumination light within the waveguide body.

Example 37 includes the augmented reality headset of Example 36, wherein the third and fourth opposing parallel sides include reflective coatings.

Example 38 is a waveguide comprising: a waveguide body having an entrance face, an end surface, and first and second opposing sides that extend between the entrance face and the end surface, the entrance face, the end surface; and a plurality of semi-reflectors disposed within the waveguide body extending between the first and second opposing sides and angled with respect to the first and second opposing sides, individual semi-reflectors of the plurality of semi-reflectors having respective different levels of angle-dependent reflectivity, with a semi-reflector positioned closest to the entrance face among the plurality of semi-reflectors having a lowest reflectivity level among the different levels of angle-dependent reflectivity.

Example 39 includes the waveguide of Example 38, wherein the waveguide body is substantially rectangular and the first and second opposing sides are substantially parallel.

Example 40 includes the waveguide of Example 39, wherein the waveguide body further includes third and fourth opposing sides that are substantially parallel to one another and substantially perpendicular to the first and second opposing sides, and wherein the third and fourth opposing sides have reflective surfaces.

Example 41 includes the waveguide of Example 40, wherein the third and fourth opposing sides include reflective coatings.

Example 42 includes the waveguide of any one of Examples 38-41, wherein the individual semi-reflectors of the plurality of semi-reflectors comprise a substrate and a semi-reflective coating on a surface of the substrate.

Example 43 includes the waveguide of Example 43, wherein a semi-reflector positioned furthest from the entrance face among the plurality of semi-reflectors includes an air gap between layers of the substrate.

Example 44 includes the waveguide of any one of Examples 38-43, wherein, for light incident on the plurality of semi-reflectors in a first range of angles of incidence, the plurality of semi-reflectors have a reflectivity value in a range of 0%-5%; and wherein, for light incident on the plurality of semi-reflectors in a second range of angles of incidence different from the first range of angles of incidence, the individual semi-reflectors have the respective different levels of angle-dependent reflectivity in a range of approximately 25% to 100%.

Example 45 includes the waveguide of Example 44, wherein the plurality of semi-reflectors includes a first semi-reflector positioned closest to the entrance face, a second semi-reflector, and a third semi-reflector, the second semi-reflector being positioned between the first and third semi-reflectors; and wherein, for the light in the second range of angles of incidence, the first semi-reflector has a reflectivity in a range of approximately 25%-34%, the second semi-reflector has a reflectivity in a range of approximately 45%-50%, and the third semi-reflector has a reflectivity in a range of approximately 80%-100%.

Example 46 includes the waveguide of Example 45, wherein the first range of angles of incidence is approximately 30-40 degrees, and wherein the second range of angles of incidence is approximately 50-60 degrees.

Example 47 includes the waveguide of any one of Examples 38-46, wherein the waveguide body is made of plastic or glass.

1. A system comprising:
a spatial light modulator; and
a waveguide having a waveguide body and a plurality of semi-reflectors disposed within the waveguide body, the waveguide body having first and second opposing sides and an entrance face that extends between the first and second opposing sides, the plurality of semi-reflectors extending between the first and second opposing sides and angled with respect to the first and second opposing sides, wherein individual semi-reflectors of the plurality of semi-reflectors have respective different levels of angle-dependent reflectivity, with a first of the plurality of semi-reflectors positioned closest to the entrance face and having a lowest reflectivity level among the different levels of angle-dependent reflectivity;
wherein the waveguide is configurable to receive illumination light via the entrance face and to direct the illumination light, via the plurality of semi-reflectors, towards the spatial light modulator; and
wherein the waveguide is configurable to receive, via the second opposing side, a projection beam from the spatial light modulator and to output the projection beam through the first opposing side.

2. The system of claim 1, wherein the individual semi-reflectors of the plurality of semi-reflectors each comprise a substrate and a semi-reflective coating on a surface of the substrate.

3. The system of claim 1, wherein:
for light incident on the plurality of semi-reflectors in a first range of angles of incidence, the plurality of semi-reflectors have a reflectivity value in a range of approximately 0%-5%; and
for light incident on the plurality of semi-reflectors in a second range of angles of incidence different from the first range of angles of incidence, the individual semi-reflectors have the respective different levels of angle-dependent reflectivity in a range of approximately 25% to 100%.

4. The system of claim 3, wherein:
the first semi-reflector positioned closest to the entrance face and has, for the light in the second range of angles of incidence, a reflectivity in a range of approximately 25%-34%;
a second semi-reflector of the plurality of semi-reflectors has, for the light in the second range of angles of incidence, a reflectivity in a range of approximately 45%-50%; and
a third semi-reflector of the plurality of semi-reflectors has, for the light in the second range of angles of incidence, a reflectivity in a range of approximately 80%-100%; and
the second semi-reflector is positioned between the first and third semi-reflectors.

5. The system of claim 4, wherein the first range of angles of incidence is approximately 30-40 degrees, and wherein the second range of angles of incidence is approximately 50-60 degrees.

6. The system of claim 1, wherein the waveguide body further includes third and fourth opposing sides positioned substantially perpendicular to, and extending between, the first and second opposing sides, and positioned substantially perpendicular to the entrance face, the third and fourth opposing sides configurable to reflect the illumination light within the waveguide body.

7. The system of claim 1, wherein the spatial light modulator is configurable to modulate the illumination light received from the waveguide to produce the projection beam.

8. A light projection system comprising:
a light source;
a spatial light modulator;
projection optics;
a waveguide optically coupled to the light source, the spatial light modulator, and the projection optics, the waveguide having a waveguide body and including a plurality of semi-reflectors disposed within the waveguide body, individual semi-reflectors of the plurality of semi-reflectors having respective different levels of angle-dependent reflectivity, and the waveguide, the spatial light modulator optically coupled to the projection optics via the waveguide; and
illumination optics optically coupled to the light source and to the waveguide, the light source optically coupled to the spatial light modulator via the illumination optics and the waveguide.

9. The light projection system of claim 8, wherein:
the light source is configurable to emit illumination light;
the illumination optics are configurable to direct the illumination light to the waveguide;
the plurality of semi-reflectors includes a first semi-reflector, a second semi-reflector, and a third semi-reflector;
the first semi-reflector configurable to reflect a first portion of the illumination light to the spatial light modulator and to transmit a second portion of the illumination light to the second semi-reflector;
the second semi-reflector configurable to reflect a third portion of the second portion of the illumination light to the spatial light modulator and to transmit a fourth portion of the second portion of the illumination light to the third semi-reflector; and
the third semi-reflector configurable to reflect the fourth portion of the second portion of the illumination light to the spatial light modulator.

10. The light projection system of claim 9, wherein:
the first portion of the illumination light is in a range of approximately 25%-34% of the illumination light; and
the third portion of the second portion of the illumination light is in a range of approximately 45%-50% of the third portion of the second portion of the illumination light.

11. The light projection system of claim 9, wherein:
the spatial light modulator is configurable to produce a projection beam responsive to the illumination light; and
the projection optics are configurable to image the projection beam onto a focal plane.

12. The light projection system of claim 9, further comprising:
a folding prism optically coupled to the illumination optics and to the waveguide, and configurable to direct the illumination light from the illumination optics into an entrance face of the waveguide.

13. The light projection system of claim 12, further comprising a light tunnel optically coupled to the illumination optics and to the folding prism, the light tunnel configurable to homogenize the illumination light received from the illumination optics and to direct the illumination light to the folding prism.

14. The light projection system of claim 9, wherein the individual semi-reflectors of the plurality of semi-reflectors comprise a substrate and a semi-reflective coating on a surface of the substrate.

15. The light projection system of claim 14, wherein the third semi-reflector includes an air gap between layers of the substrate.

16. The light projection system of claim 8, wherein:
the waveguide body is substantially rectangular, having first and second opposing parallel sides, third and fourth opposing parallel sides arranged perpendicular to the first and second opposing parallel sides, and an entrance face that extends between the first and second opposing parallel sides and between the third and fourth opposing parallel sides and is arranged perpendicular to the first and second opposing parallel sides and to the third and fourth opposing parallel sides, the third and fourth opposing parallel sides spaced apart from one another by a distance such that the waveguide exhibits total internal reflection of the illumination light within a predetermined illumination cone angle; and
each of the plurality of semi-reflectors extends between and is angled with respect to the first and second opposing parallel sides.

17. An augmented reality headset comprising:
a frame; and
a light projection system coupled to the frame and configurable to project a virtual image, the light projection system including
a light source configurable to emit illumination light,
a spatial light modulator configurable to produce a projection beam responsive to the illumination light,
a waveguide having a waveguide body and including a plurality of semi-reflectors disposed within the waveguide body and configurable to reflect the illumination light to the spatial light modulator, individual semi-reflectors of the plurality of semi-reflectors having respective different levels of angle-dependent reflectivity, and
an eyepiece configurable to receive the projection beam from the spatial light modulator via the waveguide, the eyepiece configurable to form the virtual image.

18. The augmented reality headset of claim 17, further comprising:
a display waveguide mechanically coupled to the frame and optically coupled to the eyepiece, the display waveguide configurable to relay the virtual image.

19. The augmented reality headset of claim 17, wherein the plurality of semi-reflectors includes:
a first semi-reflector configurable to reflect a first portion of the illumination light to the spatial light modulator and to transmit a second portion of the illumination light to a second semi-reflector,
the second semi-reflector configurable to reflect a third portion of the second portion of the illumination light to the spatial light modulator and to transmit a fourth portion of the second portion of the illumination light to a third semi-reflector, and
the third semi-reflector configurable to reflect the fourth portion of the second portion of the illumination light to the spatial light modulator.

20. The augmented reality headset of claim 17, wherein:
the waveguide body is substantially rectangular, having first and second opposing parallel sides and third and fourth opposing parallel sides arranged perpendicular to the first and second opposing parallel sides, the third and fourth opposing parallel sides spaced apart from one another by a distance configured for total internal reflection of the illumination light within a predetermined illumination cone angle; and each of one or more of the plurality of semi-reflectors extends between and is angled with respect to the first and second opposing parallel sides.
